(19) United States
(12) Patent Application Publication
(10) Pub. No.: US 2026/0211628 A1
(43) Pub. Date: Jul. 23, 2026

(54) SYSTEMS AND METHODS FOR MODIFYING CODE FOR AN AUTOMATED CONTROL WHILE MAINTAINING CODE COMPATIBILITY

(71) Applicant: Capital One Services, LLC, McLean, VA (US)

(72) Inventor: Shakiera Stokes, Rockville, MD (US)

(73) Assignee: Capital One Services, LLC, McLean, VA (US)

(21) Appl. No.: 19/035,770

(22) Filed: Jan. 23, 2025

(51) Int. Cl. G06F 8/30

(52) U.S. Cl. CPC G06F 8/30

(57) ABSTRACT

In some implementations, a device may input, to a model, a code script that implements a control of a plurality of controls used in a production computing environment. The device may receive, from the model, an output indicating a modified code script based on the code script, where the modified code script implements the control differently than the code script. The device may cause, based on the output, deployment of the modified code script to a testing computing environment in which a plurality of code scripts relating to the plurality of controls are deployed. The device may determine, based on an execution of the modified code script in the testing computing environment, whether the modified code script sufficiently implements the control. The device may cause deployment of the modified code script to the production computing environment based on a determination that the modified code script sufficiently implements the control.

### BACKGROUND

In recent years, the use of artificial intelligence, including, but not limited to, machine learning, deep learning, etc. (referred to collectively herein as artificial intelligence models, machine learning models, or simply models) has exponentially increased. Broadly described, artificial intelligence refers to a wide-ranging branch of computer science concerned with building smart machines capable of performing tasks that typically require human intelligence. Key benefits of artificial intelligence are its ability to process data, find underlying patterns, and/or perform real-time determinations. However, despite these benefits and despite the wide-ranging number of potential applications, practical implementations of artificial intelligence have been hindered by several technical problems. First, artificial intelligence may rely on large amounts of high-quality data. The process for obtaining this data and ensuring it is high-quality can be complex and time-consuming. Additionally, data that is obtained may need to be categorized and labeled accurately, which can be difficult, time-consuming and a manual task. Second, despite the mainstream popularity of artificial intelligence, practical implementations of artificial intelligence may require specialized knowledge to design, program, and integrate artificial intelligence-based solutions, which can limit the amount of people and resources available to create these practical implementations. Finally, results based on artificial intelligence can be difficult to review as the process by which the results are made may be unknown or obscured. This obscurity can create hurdles for identifying errors in the results, as well as improving the models providing the results. These technical problems may present an inherent problem with attempting to use an artificial intelligence-based solution in modifying a code script to sufficiently implement an automated control in the code script.

### SUMMARY

Methods and systems are described herein for novel uses and/or improvements to artificial intelligence applications. As one example, methods and systems are described herein for modifying a code script to sufficiently implement a control while ensuring compatibility of the modified code script with other code scripts that have a dependency relationship (e.g., a parent relationship or a child relationship) with the modified code script.

Automated controls can be used in connection with risk management strategies in computing systems. For example, controls may be used to enforce compliance with digital security (e.g., cybersecurity) specifications, thereby improving the stability and security of computing systems. In particular, these controls may relate to network security, application security, information security, cloud security, cloud configuration, and/or identity and access management (IAM), among other examples. As examples, a system may employ a control that enforces username and/or password requirements during account registration, a control that enforces access restrictions to secure resources, a control that enforces configuration requirements for cloud computing resources, a control that enforces compliance with data handling or storage practices, or the like. Each control that is used may be implemented in accordance with specifications (e.g., set forth in documentation) indicating purposes and requirements for the control.

An automated control may be implemented in a code script. Thus, a system employing risk management strategies may have numerous (e.g., tens, hundreds, or even thousands) of code scripts implementing various controls. Due to the volume of controls and corresponding code scripts, existing systems may have difficulty ensuring that each code script is sufficiently implementing its corresponding control in compliance with relevant specifications while also maintaining compatibility among the numerous code scripts. For example, existing systems may be unable to detect when a code script is implementing a control in a non-compliant manner, when a code script contains vulnerabilities or other defects, and/or when multiple code scripts with dependency relationships have incompatibilities. As a result, the code scripts may ineffectively implement the controls, leading to system instability, security vulnerabilities, unplanned downtime, and other inefficiencies.

To overcome these technical deficiencies, methods and systems disclosed herein identify code scripts that do not sufficiently implement controls (e.g., in accordance with relevant requirements for the controls), modify the code scripts to improve their implementation of the controls, and ensure compatibility of the modified code scripts with other code scripts. For example, a system may employ a language model to identify a code script that does not sufficiently implement a control, and to modify the code script to better implement the control. The language model may be trained on a documentation set relating to the controls, including documents such as control policy documents, control procedural documents, and/or documents relating to historical control assessments, among other examples. Based on this training, the language model may have a high level of proficiency relating to the control environment, thereby enabling the language model to accurately assess the alignment between a control's intended purpose and its implementation in a code script (e.g., using the semantic meaning and logical flow of both the control's specifications and the code script).

Moreover, upon receiving a modified code script from the language model, the system may deploy the modified code script to a testing computing environment. In the testing computing environment, the system may ensure that the modified code script sufficiently implements the control, and also ensure that the changes reflected in the modified code script do not adversely impact any other depending code script. The system may do so by performing control challenges on the modified code script as well as depending code script(s). For example, for a control that requires passwords to contain a special character, the system may perform a control challenge by attempting to register a password that does not contain a special character, thereby testing whether the control is properly implemented in the modified code script. In this way, the system facilitates early detection of unexpected behavior or vulnerabilities in the modified code script that could result in unstable or insecure deployments of the modified code script. In addition, by determining whether adverse impacts to depending code scripts are present, the system facilitates early detection of incompatibilities or vulnerabilities that could result in unstable or insecure deployments of the modified code script. Based on a determination that the modified code script sufficiently implements the control and/or a determination that the modified code script does not adversely impact depending code scripts, the system may cause deployment of the modified code script to the production computing environment. These checks ensure that the modified code script deployed to the production computing environment performs in a compliant manner that is compatible with other code scripts, thereby improving system stability and security.

In some aspects, a system for modifying code for automated controls while maintaining code compatibility may input a request to a language model, where the request includes (1) a description of a digital security control of a plurality of digital security controls used in a production computing environment, and (2) a code script that implements the digital security control, where the language model is trained on a documentation set relating to the plurality of digital security controls, and where the digital security control is a detective and corrective control or a preventative control. The system may receive, from the language model in response to the request, an output indicating (1) that the code script does not sufficiently implement the digital security control, and (2) a modified code script based on the code script, where the modified code script implements the digital security control differently than the code script. The system may cause, based on the output, deployment of the modified code script to a testing computing environment in which a plurality of code scripts relating to the plurality of digital security controls are deployed, where the modified code script is used in place of the code script in the testing computing environment. The system may determine, based on an execution of the modified code script in the testing computing environment, whether the modified code script has an adverse impact on one or more other code scripts, of the plurality of code scripts, that have a dependency relationship with the modified code script. The system may cause deployment of the modified code script to the production computing environment based on a determination that the modified code script does not adversely impact the one or more other code scripts.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for using a language model proficient in control analysis, in accordance with one or more embodiments.

FIG. 2 shows an illustrative diagram for modifying code for an automated control while maintaining code compatibility, in accordance with one or more embodiments.

FIG. 3 shows illustrative components for a system used to maintain compliance and compatibility for code implementing controls, in accordance with one or more embodiments.

FIG. 4 shows a flowchart of the steps involved in maintaining compliance and compatibility for code implementing controls, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

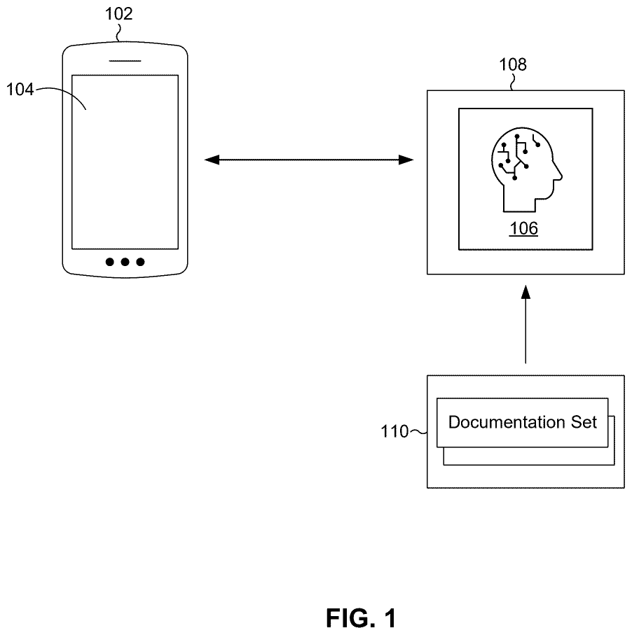

FIG. 1 shows an illustrative diagram for using a language model proficient in control analysis, in accordance with one or more embodiments. As shown in FIG. 1, a user device 102 may include a user interface 104 that facilitates communication with a language model 106. For example, the language model 106 may be implemented at a resource (e.g., a server, a cloud service, an application, an application programming interface (API) endpoint) of a system 108, and the user interface 104 may facilitate communication to and from the resource. In some embodiments, communication with the resource (e.g., an API endpoint) may be in the form of requests and responses via an API. The system 108 may be remote from the user device 102 (e.g., the system 108 may be one or more servers, a cloud computing system, or the like), or the user device 102 may include the system 108. As referred to herein, a “user interface” may comprise a human-computer interaction and communication in a device, and may include display screens, keyboards, a mouse, and the appearance of a desktop. For example, a user interface may comprise a way a user interacts with an application or a website. As referred to herein, a “machine learning language model” or “language model” may comprise a computational system designed to understand and generate human language through learning patterns in vast amounts of training data, such as books, websites, and other sources. The trained model may be able to predict and produce coherent and contextually relevant text based on input it receives. In some examples, the language model 106 may include a large language model (LLM), a transformer model, a generative pre-trained transformer (GPT) model, or another type of generative model.

In connection with use of the language model 106, text may be entered into the user interface 104, and the system 108 may obtain (e.g., receive), via the user interface 104, an input indicating a prompt (e.g., the entered text) for the language model 106. “Prompt” may refer to any text input to the language model 106 intended to produce a response from the language model 106. Similarly, the user device 102 may receive, from the system 108, an output (e.g., a response) of the language model 106, and the output may be presented in the user interface 104.

The language model 106 may be a pre-trained, general-purpose model that has been trained on a large dataset. In some embodiments, the language model 106 may be trained to interpret and generate code in various programming languages. For example, training the language model 106 may include inputting large datasets of code from various programming languages. By analyzing the training data, the language model 106 may learn patterns, syntax, and semantics for the code. During training, the language model 106 may use techniques like tokenization to break down code into smaller parts and attention mechanisms to understand context. This allows the language model 106 to generate coherent and syntactically correct code snippets based on the patterns it has learned.

The language model 106 may be fine tuned using a training documentation set relating to controls (e.g., risk management controls), such as digital security controls, used by an entity in a production computing environment. For example, the system 108 may perform training of the language model 106 using the documentation set. The documentation set may include control policy documents, control procedural documents, and/or documents relating to historical control assessments, among other examples. Control policy documents may include documents outlining the principles and rules that govern the implementation and management of controls, such as an information security policy that mandates regular password changes. Control procedural documents may include documents that provide detailed, step-by-step instructions on how to execute specific controls, like a procedure manual for conducting audits of cloud computing configurations. Documents relating to historical control assessments may include records of past evaluations and reviews of control effectiveness, such as reports that analyze the performance of controls in responding to testing challenges. In some embodiments, the documentation set may additionally, or alternatively, include documents relating to applicable laws and regulations (e.g., laws and regulations relating to the handling of personally identifiable information), documents relating to emerging threats, and/or documents relating to industry best practices (e.g., best practices for cybersecurity or best practices for handling transaction information), among other examples. These documents may enable the language model 106 to be trained with greater proactivity and adaptability for risk management.

The system 108 may retrieve the documentation set from a data node 110. The data node 110 may include a file server, a cloud storage system, a data warehouse, a data lake, or the like. Training the language model 106 using the documentation set may begin with data curation and preprocessing. Curating the documentation set may involve the selection and organization of high-quality, relevant documents pertaining to controls, such as digital security controls. The data in the documents may be cleaned and formatted into a suitable form for training, such as through tokenization, normalization, and/or removal of irrelevant information. The system 108 may load the pre-trained model and may perform various configurations of the model's hyperparameters (e.g., learning rate, batch size, etc.) to be used for the fine-tuning process. The system 108 may then input the curated and preprocessed dataset into the model (e.g., in batches). The system 108 may perform backpropagation and optimization using algorithms like gradient descent to adjust the model's weights based on the error between the model's predictions and the actual data. The system 108 may repeat this process for multiple epochs to improve model performance. The system 108 may validate the model's performance on a validation set to ensure effective learning and that the model is not overfitting.

The resulting language model 106 is able to intelligently analyze diverse control-related data, such as historical challenge assessments, policy and procedural documents, and/or code scripts associated with automated controls. Via the user interface 104, the user device 102 may receive an input indicating a question, request, and/or instruction for the language model 106, which the user device 102 may transmit to the system 108 for processing by the language model 106. For example, the input may identify one or more controls and include an instruction to analyze the one or more controls. As another example, the input may include an instruction to analyze controls relating to a particular system, service, security context, or the like. When presented with the input, the language model 106 may employ its deep understanding to identify aspects of the control environment, such as the clarity of the control objective, the appropriateness of the control's type and frequency, and the control's alignment with associated risks and regulatory requirements. The language model 106 may also analyze implementation details relating to the control. For example, the language model 106 may assess the sufficiency, reliability, and/or errors of underlying code script(s) for the control. As an example, as described herein, the language model 106 may assess the alignment between a control's intended purpose (e.g., as documented in policy and procedural documents) and the control's actual implementation in code script(s). This may involve understanding the semantic meaning and logical flow of both the documentation and the code script, thereby allowing the language model 106 to identify potential gaps or inconsistencies, and to highlight areas where the control might not be operating as designed. An output of the language model 106, based on the model's training, may include one or more insights, risk scores, questions (e.g., to guide further assessment), recommendations for remediation, flagging of missing controls (e.g., gap identification) or misalignments (e.g., between a control's purpose and its implementation), and/or counter-argument analysis.

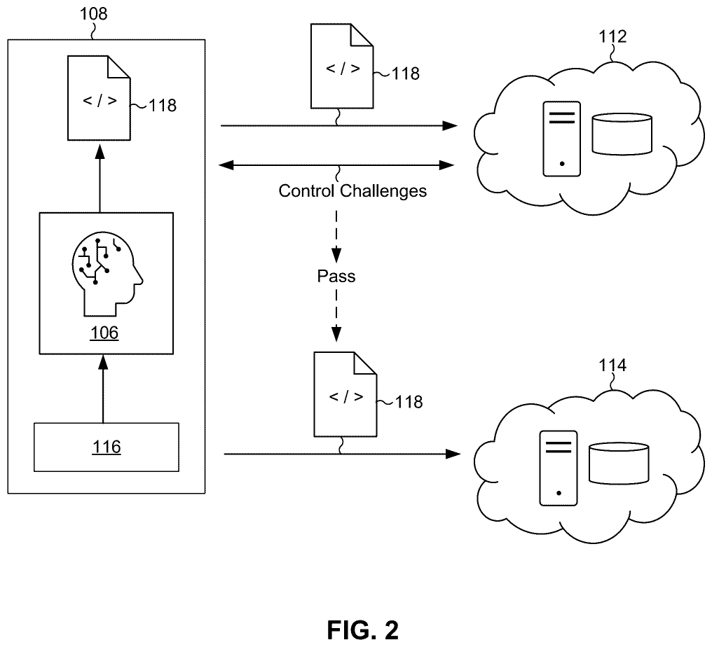

FIG. 2 shows an illustrative diagram for modifying code for an automated control while maintaining code compatibility, in accordance with one or more embodiments. As shown, FIG. 2 includes the system 108 with the language model 106, a testing computing environment 112, and a production computing environment 114. “Computing environment” may refer to a configuration of hardware, software, and/or network resources designed to support the execution and management of applications and/or services. A “testing computing environment” or “testing environment” may refer to an environment where an application is deployed to identify and fix bugs, and ensure that the code functions as expected before release. A “production computing environment” or “production environment” may refer to an environment where an application is deployed for end-users where real-world operations occur. In some embodiments, operations of the system 108 described herein may be performed in a software architecture that utilizes one or more agents (e.g., where each agent receives an input relating to a particular operation, and provides an output relating to the operation to a subsequent agent).

A plurality of code scripts relating to a plurality of controls (e.g., a digital security controls) may be deployed in the production computing environment 114, as well as deployed in the testing computing environment 112 for testing purposes. A “code script” may refer to a set of written instructions in a programming language that is intended to automate one or more operations or perform a particular function when executed. A “control” may refer to a measure or action implemented to mitigate risk by preventing, detecting, or correcting potential issues within a system.

The controls may relate to network security (e.g., controls to protect the integrity, confidentiality, and accessibility of computer networks and data), application security (e.g., controls to protect software applications from threats and vulnerabilities), information security (e.g., controls to safeguard sensitive information from unauthorized access, disclosure, alteration, or destruction), cloud security (e.g., controls to protect data, applications, and services in cloud computing environments), cloud configuration (e.g., controls relating to settings and parameters for resources of cloud services), and/or IAM (e.g., controls relating to digital identities and controlling access to resources), among other examples. The controls may be preventative controls and/or detective and corrective controls. “Preventative control” refers to a control that prevents or reduces the likelihood of a risk event occurring (e.g., multi-factor authentication to ensure that only authorized users can access a system). “Detective and corrective control” refers to a combined control that identifies the occurrence of a risk event, and implements a restorative action in response to the risk event (e.g., detecting that a user has accessed restricted resources, and blocking the user's access to the restricted resources).

The system 108 may use the language model 106 to assess whether a code script, that is intended to implement a control, has sufficiently implemented the control (e.g., in accordance with a specification for the control, requirements for the control, or the like). In some examples, the control to be assessed may be known (e.g., pre-determined). In some other examples, the system 108 may input, to the language model 106, a prompt instructing the language model 106 to identify a control that has the potential to be insufficiently implemented in a code script, and the system 108 may receive, from the language model 106, information identifying the control. In some examples, the code script corresponding to the control may be known (e.g., in accordance with a database, a mapping, a lookup table, or the like). In some other examples, the system 108 may input, to the language model 106, a prompt that includes a description of the control and an instruction to identify which of the plurality of code scripts implements the control, and the system 108 may receive, from the language model 106, an indication of the code script that implements the control.

In some embodiments, the system 108 may receive, from the user device 102, a request indicating the code script. The request may also indicate control policy documents, control procedural documents, and/or documents relating to historical control assessments, among other examples. The request may be provided via a query agent (e.g., a chatbot) of the system 108 that can receive queries to provide particular insights (e.g., “what is a risk associated with this control?”), receive queries that request clarifications on recommendations, receive queries with follow-up questions, and/or export reports relating to queries. In some embodiments, the system 108 may utilize retrieval-augmented generation (RAG) to enhance responses of the query agent with real-time contextually relevant information. For example, the system 108 may transmit queries to a database to retrieve historical control assessments or other historical data and/or may transmit requests to a web search (e.g., via an API) to retrieve information on up-to-date regulatory information, industry standards, and/or control benchmarks. The system 108 may transmit outputs that are responsive to the request from the user device 102 via the query agent.

In some embodiments, the system 108 may extract text, metadata, and structural information from the documents and/or the code script. For example, the system 108 may extract control-related sections (e.g., indicating control objectives, risk factors, and/or compliance requirements) from the documents. After identifying the control and its corresponding code script that is to be assessed, the system 108 may input another prompt 116 to the language model 106. This prompt 116 may include a description of the control (e.g., that is extracted from the documents), the code script that implements the control (e.g., the code itself or an identifier that enables retrieval of the code), and an instruction to determine whether the code script sufficiently implements the control and/or an instruction to modify the code to implement the control with greater sufficiency. The code script may “sufficiently” implement the control if the code script implements all of the required features for the control, and the implementation of those features perform in accordance with a specified manner. For example, the language model 106 may analyze the code script for security vulnerabilities, coding flaws, and/or misalignments with the documentation. In response, the system 108 may receive, from the language model 106, an output indicating whether the code script sufficiently implements the control. Additionally, or alternatively, the output may indicate control design weaknesses in the code script, missing documentation, process deviations in the code script, insights relating to risk, and/or a score indicating a severity of a misalignment of the code script with the control. In some embodiments, the system 108 may generate, using the language model 106, one or more challenge questions and/or context-aware queries that are designed to assess the sufficiency of the code script and/or the documentation. In some embodiments, the system 108 may generate, using the language model 106, one or more recommendations for updating the documentation, one or more recommendations for modifying the code script, and one or more recommendations of strategies to control risk. In some embodiments, the system 108 may compare the output with documents relating to historical control assessments (e.g., which may indicate previous resolutions) to identify patterns of recurring issues and/or to validate the output (e.g., whether the output is aligned with industry standards). The system 108 may provide various outputs to the user device 102 via the query agent. The system 108 may also log the output, which can be used with predictive modeling to forecast emerging trends.

In an example, the system 108 may receive, from the language model 106, an output indicating that the code script does not sufficiently implement the control, and a modified code script 118 based on the original code script. The modified code script 118 may implement the control differently than the original code script. For example, the modified code script 118 may have one or more changes relative to the original code script. The changes may introduce features that are required for the control but that were not implemented by the original code script, may provide fixes for vulnerabilities in the original code script, or the like.

Based on receiving the modified code script 118 (e.g., the language model 106 has indicated that the original code script does not sufficiently implement the control), the system 108 may cause deployment of the modified code script 118 (e.g., a digital file containing the modified code script) to the testing computing environment 112. As described herein, the plurality of code scripts may be deployed to the testing computing environment 112, and deployment of the modified code script 118 may result in the modified code script 118 being used in place of the original code script in the testing computing environment 112. In some embodiments, to cause deployment of the modified code script 118, the system 108 may initiate a build process in which the modified code script 118 is compiled and packaged into a deployable artifact. Accordingly, deployment of the modified code script 118 may refer to deployment of the deployable artifact.

Once deployed, the system 108 may determine whether the modified code script 118 sufficiently implements the control. Additionally, or alternatively, the system 108 may determine whether the modified code script 118 has an adverse impact on one or more other code scripts deployed in the testing computing environment 112. These other code scripts may have a dependency relationship with the modified code script 118. For example, a depending code script may have a parent dependency relationship with the modified code script 118 (e.g., the depending code script contains or controls the modified code script 118). As another example, a depending code script may have a child dependency relationship with the modified code script 118 (e.g., the depending code script is contained by or controlled by the modified code script 118). In some embodiments, the system 108 may identify code scripts having dependency relationships with the modified code script 118. For example, the system 108 may input, to the language model 106, a prompt that indicates the modified code script 118, the original code script, and/or the control, and that includes an instruction to identify other code scripts that have a dependency relationship with the modified code script/original code script, and the system 108 may receive, from the language model 106, an indication of one or more depending code scripts.

To determine whether the modified code script 118 sufficiently implements the control, the system 108 may perform one or more control challenges relating to the control. “Control challenge” may refer to one or more operations designed to test whether a code script implements a control in accordance with a set of specifications for the control. For example, for a control that requires passwords to contain a special character, the system 108 may perform a control challenge by attempting to register a password that does not contain a special character, thereby testing whether the control is properly implemented. To perform a control challenge, the system 108 may transmit (e.g., to a device that implements the testing computing environment) a request message containing data relating to the control challenge, and receive a response message containing data relating to an output produced by a code script, which the system 108 may process to identify passing or failing of the control challenge. Thus, a control challenge performed by the system 108 may result in an execution of the modified code script 118 in the testing computing environment 112. The system 108 may determine whether the modified code script 118 passes the control challenge(s), and may determine that the modified code script 118 sufficiently implements the control if the modified code script 118 passes the control challenge(s).

To determine whether the modified code script 118 has an adverse impact on depending code scripts, the system may perform one or more control challenges relating to a depending code script. Because the depending code script may have a dependency relationship with the modified code script 118, the control challenge(s) may also result in an execution of the modified code script 118 in the testing computing environment 112. Accordingly, errors or other incompatibilities in the modified code script 118 may result in the depending code scripts failing the control challenge(s). Thus, the system 108 may determine whether the depending code script passes the control challenge(s), and may determine whether the modified code script 118 adversely impacts the depending code script based on whether the depending code script passes the control challenge(s).

Based on a determination that the modified code script 118 sufficiently implements the control and/or a determination that the modified code script 118 does not adversely impact depending code scripts, the system 108 may cause deployment of the modified code script 118 (e.g., a digital file containing the modified code script) to the production computing environment 114. The modified code script 118 deployed to the production computing environment 114 can be used to implement automated controls (e.g., risk management controls) in the production computing environment 114. For example, the modified code script 118 can be used to implement a digital security control, such as a control that enforces username and/or password requirements during account registration, a control that enforces access restrictions to secure resources, a control that enforces configuration requirements for cloud computing resources, a control that enforces compliance with data handling or storage practices, or the like. In some embodiments, the modified code script 118 may be a component of a website, an intranet site, a backend server, a cloud computing service, or the like. In some embodiments, a system (e.g., system 108 or another system) may cause execution of the modified code script 118 in the production computing environment 114 in connection with an account registration operation performed by a user device, a request (e.g., an HTTP request) by a user device to access a resource, a cloud service provisioning operation, a data storage or data retrieval operation, or the like.

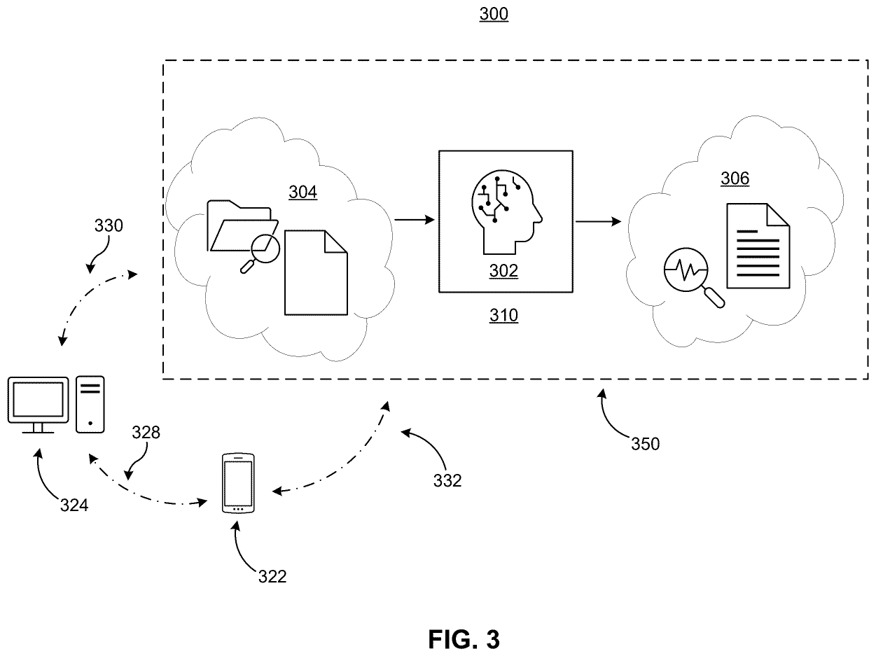

FIG. 3 shows illustrative components for a system used to maintain compliance and compatibility for code implementing controls, in accordance with one or more embodiments. For example, FIG. 3 may show illustrative components for modifying code for an automated control while maintaining code compatibility. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system, and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include language model 106, system 108, testing computing environment 112, and/or production computing environment 114. Cloud components 310 may access data sources that include control definitions, code scripts, and/or a documentation set relating to the controls.

Cloud components 310 may include model 302, which may be a machine learning model, artificial intelligence model, etc. (which may be referred collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., sufficiently implements a control).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., sufficiently implements a control, does not sufficiently implement a control, or the like).

In some embodiments, the model (e.g., model 302) may automatically perform actions based on outputs 306. In some embodiments, the model (e.g., model 302) may not perform any actions. The output of the model (e.g., model 302) may be used to modify a code script to sufficiently implement a control.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API Platforms and their modules. API layer 350 may use a developer portal. API layer 350 may use strong security constraints applying WAF and DDoS protection, and API layer 350 may use RESTful APIs as standard for external integration.

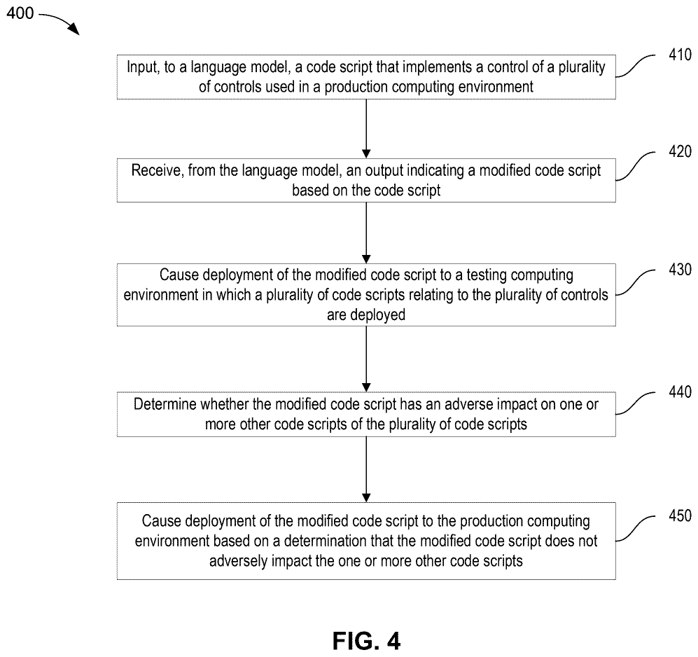

FIG. 4 shows a flowchart of the steps involved in maintaining compliance and compatibility for code implementing controls, in accordance with one or more embodiments. For example, the system may use process 400 (e.g., as implemented on one or more system components described above) in order to modify code for an automated control while maintaining code compatibility.

At step 410, process 400 (e.g., using one or more components described above) may include inputting a code script to a language model. For example, the system may input, to a language model, a code script that implements a control of a plurality of controls used in a production computing environment. As an example, the system may input, to the language model, a request (e.g., a prompt) that includes (1) a description of the control, (2) the code script, and (3) an instruction to determine whether the code script sufficiently implements the control. As described herein, the language model may be trained on a documentation set relating to the plurality of controls. For example, the documentation set may include control policy documents, control procedural documents, and/or documents relating to historical control assessments, among other examples. Thus, this information-rich input to the language model (e.g., in the form of the prompt) improves the model's performance and ability to generate a relevant and quality output based on its training.

At step 420, process 400 (e.g., using one or more components described above) may include receiving an output indicating a modified code script. For example, the system may receive, from the language model, an output indicating a modified code script based on the code script. As an example, the modified code script may implement the control differently than the code script. For example, the language model may generate the modified code script based on a purpose of the control, requirements for the control, historical assessments of the control and/or the code script, or the like, as indicated in the model's training data. Thus, the modified code script may implement the control with improved accuracy to the purpose and requirements of the control, as well as reduce vulnerabilities in the code. In this way, the modified code script may better align with the control's intended use, thereby improving network security, application security, information security, cloud security, or IAM, among other examples (e.g., in accordance with the purpose of the control).

At step 430, process 400 (e.g., using one or more components described above) may include causing deployment of the modified code script to a testing computing environment. For example, the system may cause, based on the output, deployment of the modified code script to a testing computing environment in which a plurality of code scripts relating to the plurality of controls are deployed. As an example, the testing computing environment may include the code scripts for all automated controls, but the modified code script may be used in place of the code script in the testing computing environment. This allows simulation of interactions between the modified code script and other code scripts without risking destabilization or introducing vulnerabilities in a production computing environment. In particular, the control may have a parent dependency relationship or a child dependency relationship with one or more other controls, and thus, the modified code script may introduce incompatibilities with other related code scripts. The testing computing environment facilities such code incompatibilities to be resolved without destabilizing or introducing security vulnerabilities in the production computing environment.

At step 440, process 400 (e.g., using one or more components described above) may include determining whether the modified code script has an adverse impact on other code scripts. For example, the system may determine, based on an execution of the modified code script in the testing computing environment, whether the modified code script has an adverse impact on other code scripts deployed in the testing computing environment. As an example, the modified code script may execute in a sequence with one or more parent code scripts and/or one or more child code scripts, which may adversely impact a parent code script and/or a child code script due to the changes made in the modified code script. By determining whether such adverse impacts are present, the system facilitates early detection of incompatibilities or vulnerabilities that could result in unstable or insecure deployments of the modified code script. The system may also determine, based on an execution of the modified code script in the testing computing environment, whether the modified code script performs as intended and sufficiently implements the control. In this way, the system facilitates early detection of unexpected behavior or vulnerabilities in the modified code script that could result in unstable or insecure deployments of the modified code script.

In some embodiments, to determine whether the modified code script has adverse impacts on other code scripts, process 400 may include performing, in the testing computing environment, a control challenge relating to an additional control implemented by an additional code script. Because the additional code script may have a dependency relationship with the modified code script, the control challenge may also implicate the modified code script, and errors or other incompatibilities in the modified code script may result in the additional code script failing the control challenge. Based on performing the control challenge, process 400 may include determining whether the additional code script passes or fails the control challenge, thereby indicating whether the modified code script has an adverse impact on the additional code script. In a similar manner, to determine whether the modified code script sufficiently implements the control, process 400 may include performing, in the testing computing environment, a control challenge relating to the control implemented by the modified code script. Based on performing the control challenge, process 400 may include determining whether the modified code script passes or fails the control challenge, thereby indicating whether the modified code script sufficiently implements the control. The control challenges verify that the code scripts behave as expected under various conditions, as well as identify weaknesses or vulnerabilities in the code scripts. In this way, the control challenges increase the reliability, stability, and security of the code scripts, leading to fewer bugs, crashes, downtime, and/or security breaches.

In some embodiments, based on determining that the modified code script does not adversely impact other code scripts and/or determining that the modified code script sufficiently implements the control, process 400 may include transmitting, to a user device, an indication that the modified code script does not adversely impact the one or more other code scripts and/or sufficiently implements the control, and receiving, from the user device in response to the indication, an authorization to deploy the modified code script to the production computing environment. By doing so, only approved changes of the modified code script can be deployed to the production computing environment, thereby reducing the risk of deploying buggy or non-compliant code. Moreover, this authorization facilitates control over the deployment process, such as by facilitating scheduling of deployments at times that minimize service interruptions. For example, the authorization to deploy the modified code script may indicate a set of deployment parameters, such as a time for deployment, whether the modified code script should be enabled or disabled by default, a deployment strategy (e.g., a blue-green deployment), one or more configuration settings for the modified code script, and/or one or more entities that should be notified in the event of deployment errors, among other examples.

In some embodiments, based on determining that the modified code script has an adverse impact on an additional code script, process 400 may include inputting the additional code script into the language model with an instruction to modify the additional code script to agree with the modified code script. Process 400 may further include receiving, from the language model, a modified additional code script that is based on the additional code script, and causing deployment of the modified additional code script to the testing computing environment. Thus, the modified additional code script can be used in place of the original additional code script in the testing computing environment, and a further round of control challenges may be performed. Any additional rounds of code script modification and control challenges can be performed until the control challenges are passed, thereby indicating that the modified code script and other code scripts with dependency relationships thereon are compatible and implementing their controls in accordance with corresponding specifications.

At step 450, process 400 (e.g., using one or more components described above) may include causing deployment of the modified code script. For example, the system may cause deployment of the modified code script to the production computing environment based on a determination that the modified code script does not adversely impact the one or more other code scripts. In some embodiments, process 400 may also include causing deployment of any modified additional code scripts in the production computing environment. As an example, the system may cause deployment of the modified code script, and any modified additional code scripts, to the production computing environment if the control challenges reveal that the modified code script and other code scripts with dependency relationships thereon are compatible and implementing their controls in accordance with corresponding specifications. In this way, code scripts deployed to the production computing environment have been validated for compatibility and efficacy in implementing various controls, thereby improving stability, security, and reliability in the production computing environment. In some embodiments, the system may cause deployment of the modified code script to the production computing environment based on receiving an authorization, as described herein. Moreover, the deployment may be in accordance with a set of deployment parameters indicated by the authorization.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for modifying code for automated controls while maintaining code compatibility.
2. The method of embodiment 1 comprising: inputting, by a device to a language model, a code script that implements a control of a plurality of controls used in a production computing environment, wherein the language model is trained on a documentation set relating to the plurality of controls; receiving, by the device from the language model, an output indicating a modified code script based on the code script, wherein the modified code script implements the control differently than the code script; causing, by the device based on the output, deployment of the modified code script to a testing computing environment in which a plurality of code scripts relating to the plurality of controls are deployed, wherein the modified code script is used in place of the code script in the testing computing environment; determining, based on an execution of the modified code script in the testing computing environment, whether the modified code script has an adverse impact on one or more other code scripts of the plurality of code scripts; and causing deployment of the modified code script to the production computing environment based on a determination that the modified code script does not adversely impact the one or more other code scripts.
3. The method of any one of the preceding embodiments, further comprising: performing training of the language model using the documentation set relating to the plurality of controls, wherein the documentation set includes one or more of control policy documents, control procedural documents, or documents relating to historical control assessments.
4. The method of any one of the preceding embodiments, further comprising: transmitting, to a user device, an indication that the modified code script does not adversely impact the one or more other code scripts; and receiving, from the user device in response to the indication, an authorization to deploy the modified code script to the production computing environment, wherein causing deployment of the modified code script to the production computing environment is further based on receiving the authorization.
5. The method of any one of the preceding embodiments, wherein determining whether the modified code script has the adverse impact comprises: performing, in the testing computing environment, a control challenge relating to an additional control, of the plurality of controls, implemented by an additional code script of the plurality of code scripts; and determining whether the additional code script passes the control challenge.
6. The method of any one of the preceding embodiments, further comprising: determining, based on the execution of the modified code script in the testing computing environment, whether the modified code script sufficiently implements the control.
7. The method of embodiment 6, wherein determining whether the modified code script sufficiently implements the control comprises: performing, in the testing computing environment, a control challenge relating to the control implemented by the modified code script; and determining whether the modified code script passes the control challenge.
8. The method of any one of the preceding embodiments, wherein the one or more other code scripts have at least one of a parent dependency relationship with the modified code script or a child dependency relationship with the modified code script.
9. The method of any one of the preceding embodiments, further comprising: inputting, to the language model, a request that includes (1) a description of the control, and (2) an instruction to identify which one of the plurality of code scripts implements the control; and receiving, from the language model, an indication of the code script that implements the control.
10. The method of any one of the preceding embodiments, wherein inputting the code script comprises: inputting, to the language model, a request that includes (1) a description of the control, (2) the code script, and (3) an instruction to determine whether the code script sufficiently implements the control.
11. The method of any one of the preceding embodiments, further comprising: determining that the modified code script has an adverse impact on an additional code script of the plurality of code scripts; inputting the additional code script into the language model with an instruction to modify the additional code script to agree with the modified code script; receiving, from the language model, a modified additional code script that is based on the additional code script; and causing deployment of the modified additional code script to the testing computing environment, wherein the modified additional code script is used in place of the additional code script in the testing computing environment.
12. The method of embodiment 11, wherein causing deployment of the modified code script to the production computing environment comprises: causing deployment of the modified code script and the modified additional code script in the production computing environment.
13. The method of any one of the preceding embodiments, wherein the control relates to one or more of: network security, application security, information security, cloud security, cloud configuration, or identity and access management.
14. The method of any one of the preceding embodiments, further comprising: inputting, to the language model, a request that (1) indicates the modified code script, and (2) includes an instruction to identify any of the plurality of code scripts that have a dependency relationship with the modified code script; and receiving, from the language model, an indication of the one or more other code scripts having the dependency relationship with the modified code script.
15. One or more non-transitory, computer-readable mediums storing instructions that, when executed by a data processing apparatus, cause the data processing apparatus to perform operations comprising those of any of embodiments 1-14.
16. A system comprising one or more processors; and memory storing instructions that, when executed by the processors, cause the processors to effectuate operations comprising those of any of embodiments 1-14.
17. A system comprising means for performing any of embodiments 1-14.

What is claimed is:

1. A system for modifying code for automated controls while maintaining code compatibility, the system comprising:
one or more memories; and
one or more processors, communicatively coupled to the one or more memories, configured to:
input a request to a language model, wherein the request includes (1) a description of a digital security control of a plurality of digital security controls used in a production computing environment, and (2) a code script that implements the digital security control,
wherein the language model is trained on a documentation set relating to the plurality of digital security controls, and
wherein the digital security control is a detective and corrective control or a preventative control;
receive, from the language model in response to the request, an output indicating (1) that the code script does not sufficiently implement the digital security control, and (2) a modified code script based on the code script,
wherein the modified code script implements the digital security control differently than the code script;
cause, based on the output, deployment of the modified code script to a testing computing environment in which a plurality of code scripts relating to the plurality of digital security controls are deployed,
wherein the modified code script is used in place of the code script in the testing computing environment;
determine, based on an execution of the modified code script in the testing computing environment, whether the modified code script has an adverse impact on one or more other code scripts, of the plurality of code scripts, that have a dependency relationship with the modified code script; and
cause deployment of the modified code script to the production computing environment based on a determination that the modified code script does not adversely impact the one or more other code scripts.

2. A method for modifying code for automated controls while maintaining code compatibility, the method comprising:
inputting, by a device to a language model, a code script that implements a control of a plurality of controls used in a production computing environment,
wherein the language model is trained on a documentation set relating to the plurality of controls;
receiving, by the device from the language model, an output indicating a modified code script based on the code script,
wherein the modified code script implements the control differently than the code script;
causing, by the device based on the output, deployment of the modified code script to a testing computing environment in which a plurality of code scripts relating to the plurality of controls are deployed,
wherein the modified code script is used in place of the code script in the testing computing environment;
determining, based on an execution of the modified code script in the testing computing environment, whether the modified code script has an adverse impact on one or more other code scripts of the plurality of code scripts; and
causing deployment of the modified code script to the production computing environment based on a determination that the modified code script does not adversely impact the one or more other code scripts.

3. The method of claim 2, further comprising:
performing training of the language model using the documentation set relating to the plurality of controls, wherein the documentation set includes one or more of control policy documents, control procedural documents, or documents relating to historical control assessments.

4. The method of claim 2, further comprising:
transmitting, to a user device, an indication that the modified code script does not adversely impact the one or more other code scripts; and
receiving, from the user device in response to the indication, an authorization to deploy the modified code script to the production computing environment,
wherein causing deployment of the modified code script to the production computing environment is further based on receiving the authorization.

5. The method of claim 2, wherein determining whether the modified code script has the adverse impact comprises:
performing, in the testing computing environment, a control challenge relating to an additional control, of the plurality of controls, implemented by an additional code script of the plurality of code scripts; and
determining whether the additional code script passes the control challenge.

6. The method of claim 2, further comprising:
determining, based on the execution of the modified code script in the testing computing environment, whether the modified code script sufficiently implements the control.

7. The method of claim 6, wherein determining whether the modified code script sufficiently implements the control comprises:
performing, in the testing computing environment, a control challenge relating to the control implemented by the modified code script; and
determining whether the modified code script passes the control challenge.

8. The method of claim 2, wherein the one or more other code scripts have at least one of a parent dependency relationship with the modified code script or a child dependency relationship with the modified code script.

9. The method of claim 2, further comprising:
inputting, to the language model, a request that includes (1) a description of the control, and (2) an instruction to identify which one of the plurality of code scripts implements the control; and
receiving, from the language model, an indication of the code script that implements the control.

10. The method of claim 2, wherein inputting the code script comprises:
inputting, to the language model, a request that includes (1) a description of the control, (2) the code script, and (3) an instruction to determine whether the code script sufficiently implements the control.

11. The method of claim 2, further comprising:
determining that the modified code script has an adverse impact on an additional code script of the plurality of code scripts;
inputting the additional code script into the language model with an instruction to modify the additional code script to agree with the modified code script;
receiving, from the language model, a modified additional code script that is based on the additional code script; and
causing deployment of the modified additional code script to the testing computing environment,
wherein the modified additional code script is used in place of the additional code script in the testing computing environment.

12. The method of claim 11, wherein causing deployment of the modified code script to the production computing environment comprises:
causing deployment of the modified code script and the modified additional code script in the production computing environment.

13. The method of claim 2, wherein the control relates to one or more of: network security, application security, information security, cloud security, cloud configuration, or identity and access management.

14. The method of claim 2, further comprising:
inputting, to the language model, a request that (1) indicates the modified code script, and (2) includes an instruction to identify any of the plurality of code scripts that have a dependency relationship with the modified code script; and
receiving, from the language model, an indication of the one or more other code scripts having the dependency relationship with the modified code script.

15. A non-transitory, computer-readable medium, comprising instructions that, when executed by one or more processors, cause operations comprising:
inputting, to a model, a code script that implements a control of a plurality of controls used in a production computing environment;
receiving, from the model, an output indicating a modified code script based on the code script,
wherein the modified code script implements the control differently than the code script;
causing, based on the output, deployment of the modified code script to a testing computing environment in which a plurality of code scripts relating to the plurality of controls are deployed,
wherein the modified code script is used in place of the code script in the testing computing environment;
determining, based on an execution of the modified code script in the testing computing environment, whether the modified code script sufficiently implements the control; and
causing deployment of the modified code script to the production computing environment based on a determination that the modified code script sufficiently implements the control.

16. The non-transitory, computer-readable medium of claim 15, wherein the instructions further cause operations comprising:
performing training of the model using a documentation set relating to the plurality of controls, wherein the documentation set includes one or more of control policy documents, control procedural documents, or documents relating to historical control assessments.

17. The non-transitory, computer-readable medium of claim 15, wherein the instructions further cause operations comprising:
transmitting, to a user device, an indication that the modified code script sufficiently implements the control; and
receiving, from the user device in response to the indication, an authorization to deploy the modified code script to the production computing environment,
wherein causing deployment of the modified code script to the production computing environment is further based on receiving the authorization.

18. The non-transitory, computer-readable medium of claim 15, wherein the instructions for determining whether the modified code script sufficiently implements the control, cause operations comprising:
performing, in the testing computing environment, a control challenge relating to the control implemented by the modified code script; and
determining whether the modified code script passes the control challenge.

19. The non-transitory, computer-readable medium of claim 15, wherein the instructions further cause operations comprising:
inputting, to the model, a request that includes (1) a description of the control, and (2) an instruction to identify which one of the plurality of code scripts implements the control; and
receiving, from the model, an indication of the code script that implements the control.

20. The non-transitory, computer-readable medium of claim 15, wherein the instructions for inputting the code script, cause operations comprising:
inputting, to the model, a request that includes (1) a description of the control, (2) the code script, and (3) an instruction to determine whether the code script sufficiently implements the control.
